(19) United States
(12) Patent Application Publication
(10) Pub. No.: US 2013/0111333 A1
(43) Pub. Date: May 2, 2013

(54) SCALING OBJECTS WHILE MAINTAINING OBJECT STRUCTURE

(71) Applicants: Ali Taleghani, Seattle, WA (US); Jessica Arwen Best, Bellevue, WA (US); Tristan Davis, Redmond, WA (US); Victor Kozyrev, Issaquah, WA (US); Sergey Genkin, Redmond, WA (US)

(72) Inventors: Ali Taleghani, Seattle, WA (US); Jessica Arwen Best, Bellevue, WA (US); Tristan Davis, Redmond, WA (US); Victor Kozyrev, Issaquah, WA (US); Sergey Genkin, Redmond, WA (US)

(73) Assignee: MICROSOFT CORPORATION, Redmond, WA (US)

(21) Appl. No.: 13/286,063

(22) Filed: Oct. 31, 2011

(51) Int. Cl. G06F 17/00

(52) U.S. Cl. 715/252

(57) ABSTRACT

Objects are scaled by scaling properties that affect a physical layout of the object. A scaling factor is determined and each of the determined properties for an object are scaled based on the scaling factor. For example, when scaling a table, properties such as width, height, border widths, padding, text spacing, margins, indents, font size, cells, columns, and the like, may be scaled based on the scaling factor. Determined properties of any objects that are contained within an object are also scaled based on the scaling factor. The scaling process is repeated for each object that is contained within an object. After scaling, a user may still interact with the object in the same manner as before scaling. One or more ranges may be selected within a document where scaling is desired that include all/portion of the document.

### BACKGROUND

It is common for documents to be resized. A document may be resized for better readability, printing, a different display size, and the like. However, many documents are created with an intimate knowledge of their original size (e.g. a table that is sized to make optimal use of the page's width). Resizing objects in the document can result in at least a portion of the contents to scale improperly, and to reflow in a way different from its original intent. For example, after scaling, a table within the document may not be readable (e.g. labels misaligned with the corresponding data).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Objects are scaled by scaling properties that affect a physical on-screen display-layout of the object. A scaling factor is determined and each of the determined properties for an object are scaled based on the scaling factor. For example, when scaling a table, properties such as width, height, border widths, padding, text spacing, margins, indents, font size, cells, columns, and the like, may be scaled based on the scaling factor. Determined properties of any objects that are contained within an object are also scaled based on the scaling factor. The scaling process is repeated for each object that is contained within an object. After scaling, a user may still interact with the object in the same manner as before scaling. One or more ranges/types of object may be selected within a document where scaling is desired that include all/portion of the document.

### BRIEF DESCRIPTION OF THE DRAWINGS

FIG. 1 illustrates an exemplary computing device;

FIG. 2 illustrates an exemplary system for scaling objects within a document;

FIG. 3 shows a process for scaling objects by scaling properties of the objects; and

FIG. 4 illustrates a process for accessing a document and selecting a range within the document for scaling.

### DETAILED DESCRIPTION

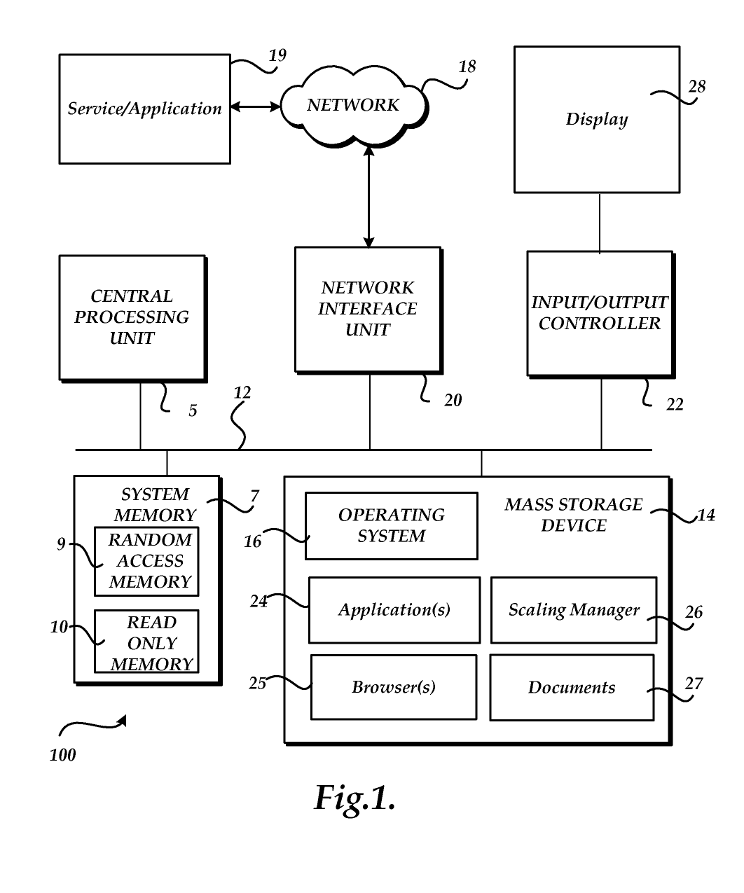

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop computing device, a server computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, and other program modules, such as Web browser applications 25, documents 27, and scaling manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, with respect to the Unified Communications via application-specific logic integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a computer, such as the WINDOWS 7®, WINDOWS SERVER®, operating systems from MICROSOFT CORPORATION of Redmond, Wash.

The mass storage device 14 and RAM 9 may also store one or more program modules. In particular, the mass storage device 14 and the RAM 9 may store one or more applications 24, such as productivity applications, and may store one or more Web browsers 25. The Web browser 25 is operative to request, receive, render, and provide interactivity with electronic documents, such as a Web page. According to an embodiment, the Web browser comprises the INTERNET EXPLORER Web browser application program from MICROSOFT CORPORATION and the applications 24 are the MICROSOFT OFFICE suite of applications.

Scaling manager 26 is configured to scale objects while maintaining the structure of the object. Scaling manager 26 may be a part of one or more different applications/services. For example, scaling manager 26 may be a part of a cloud based multi-tenant service that provides resources (e.g. services, data . . . ) to different tenants. Scaling manager 26 may be a part of other programs/services 19, such as, but not limited to: word processing applications, presentation applications, spreadsheet applications, drawing applications, and the like. According to an embodiment, scaling manager 26 operates in conjunction with the MICROSOFT OFFICE applications. The applications may be available online in a cloud based service and/or may be installed on a client computing device. Generally, objects are scaled by scaling properties that affect a physical on-screen display layout of the object. A scaling factor is determined and each of the properties selected for adjustment for an object are scaled based on the scaling factor. For example, when scaling a table, properties such as width, height, border widths, padding, text spacing, margins, indents, font size, cells, columns, and the like, may be scaled based on the scaling factor. Properties of any objects that are contained within an object are also scaled based on the scaling factor. The scaling process is repeated for each object that is contained within an object. After scaling, a user may still interact with the object in the same manner as before scaling. One or more ranges/type of objects may be selected within a document where scaling is desired that include all/portion of the document. The scaling factor may be determined for each object/range/type of object. Additional details regarding the operation of scaling manager 26 will be provided below.

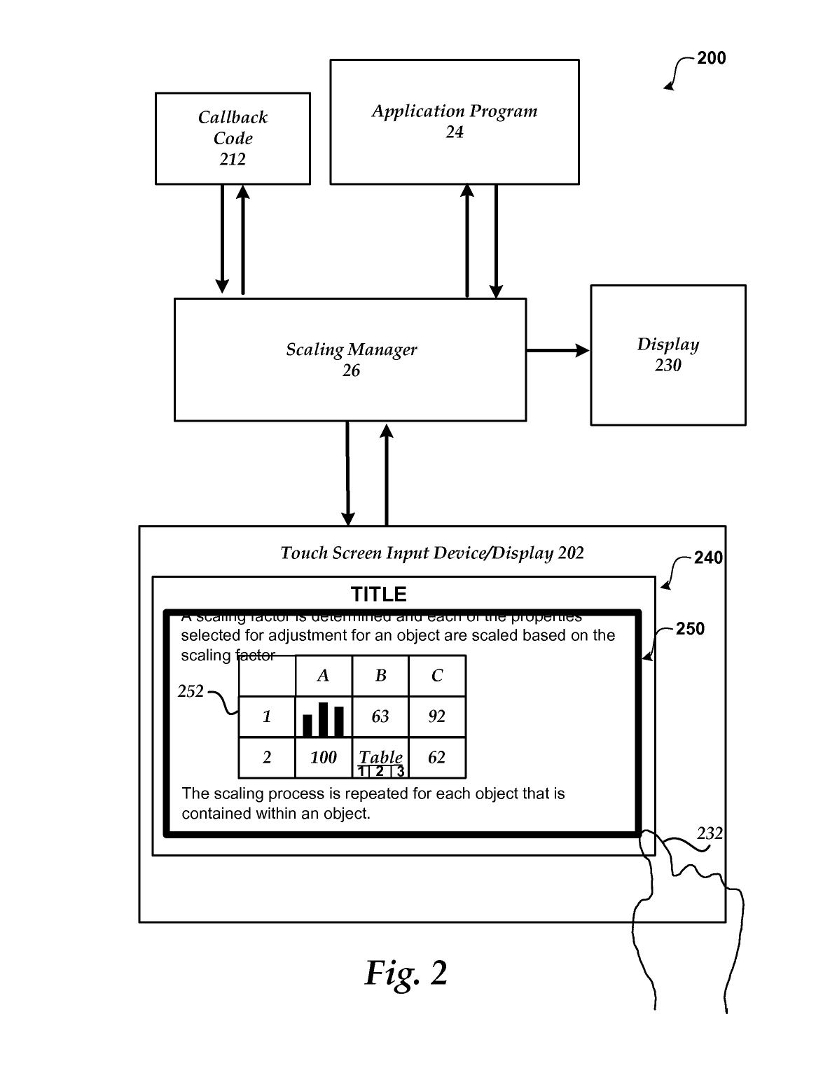

FIG. 2 illustrates an exemplary system for scaling objects within a document. As illustrated, system 200 includes application program 24, callback code 212, scaling manager 26, display 230, and touch screen input device/display 202.

In order to facilitate communication with the scaling manager 26, one or more callback routines, illustrated in FIG. 2 as callback code 212 may be implemented. According to one embodiment, application program 24 is an application that is configured to receive input from a touch-sensitive input device 202. For example, scaling manager 26 may provide information to application 24 in response to a user's finger (i.e. finger on hand 232) selecting a range within a document to which to apply a scaling factor. Scaling manager may also provide other information to application 24 (e.g. characteristics of the device).

Touch input system 200 as illustrated comprises a touch screen input device 202 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

Scaling manager 26 is configured to scale objects while maintaining the structure of the objects within a document, such as document 240. The document may be associated with one or more applications. For example, the document may be a word-processing document, a spreadsheet document, a presentation document (e.g. a slide), a drawing, and the like. Scaling manager 26 is configured to operate in conjunction with the application 24 that displays the document. Application 24 may be available online in a cloud based service and/or may be installed on a client computing device.

A document or a portion of a document may be scaled for a variety of reasons. For example, a document may be resized to enhance the readability of the document, fit the document to a size of the display, and the like. A user may select a desired size to scale the document/selected range(s) (e.g. 25%, 50%, 75%, 110%, 200%, . . . ). The scale may also be automatically determined. For example, the scale may be based on a size of the display, predetermined readability settings (e.g. 60-75 characters per line), and the like.

According to an embodiment, one or more ranges within the document may be selected to which the scaling is applied. In the current example, a user has used their hand 232 to select range 250 that selects an area of the document below the title of the document. More than one range within the document may be selected. According to an embodiment, each of the objects in the document is initially selected as a range to scale. The content and any objects within the selected range are scaled. In the present example, a spreadsheet object 252 is included between two text elements that have been selected. Spreadsheet object 252 includes a graph object at location A1 and a table object at location B2 within the spreadsheet.

Scaling manager 26 is configured to identify the objects and content within the range(s) to scale and to determine the properties of each of the objects that define a physical layout/characteristic of the object. Generally, any property of an object that specifies a physical size may be a property that may be selected for scaling. Some example physical properties of an object may include: width, height, border widths, padding, text spacing, margins, indents, font size, cells, and the like. The physical layout properties of the object are typically accessible by the application program 24 that displays the object. Scaling manager 26 determines the properties of each object to scale. A portion/all of the properties affecting the layout of the object may be scaled. Generally, the more properties that are scaled the better looking the scaled object appears. According to an embodiment, each parameter that is determined to affect a physical layout of the object is selected for scaling. According to another embodiment, a majority of the parameters of the object are selected for scaling. Any number of parameters between these ranges may be used for one or more of the objects determined to scale.

Scaling manager 26 scales each of the determined properties of each object. After scaling, the object still maintains its structure. As such, a user may still interact with the object in the same manner as before scaling the object For example, spreadsheet object 252 maintains individually navigable cells and the content within the object remains accessible as it was before the scaling. Similarly, any anchored content (e.g. comment, footnote, bookmarks . . . ) remains anchored to the content in the document.

The scaling process is repeated for each object that is contained within an object and for each other object within the range of the document that is selected for scaling. Each type of object that is scaled may have different parameters selected for scaling. For example, a spreadsheet object may have different parameters selected for scaling as compared to a graph object and/or a table object.

According to an embodiment, a minimum size may be set for one or more parameters. For example, a width of a border/line may be set to a minimum size that is still viewable. As such, when a determination is made that a scaled parameter falls below the minimum size, the scaled parameter may be set to the minimum size.

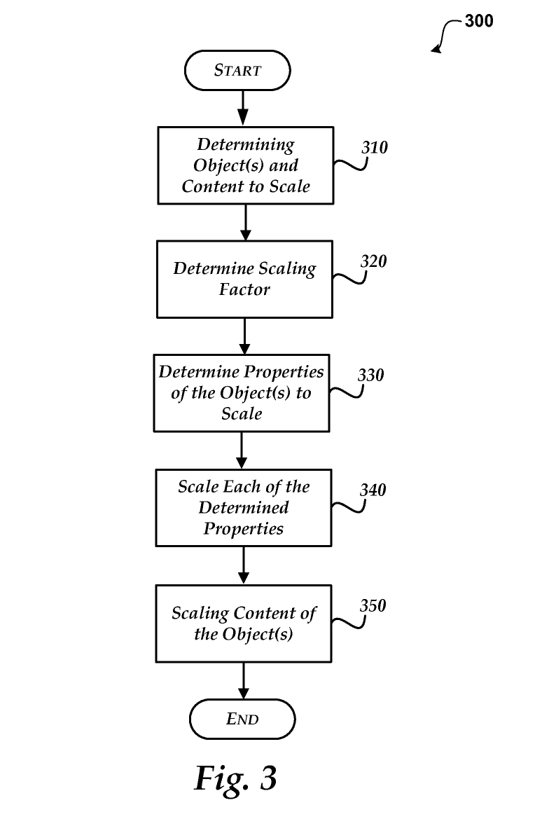

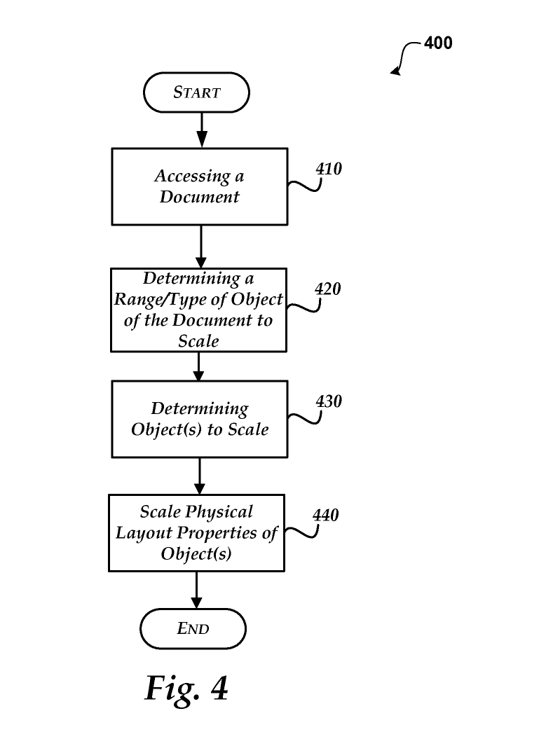

FIGS. 3 and 4 shows illustrative processes for scaling objects while maintaining object structure. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the order of the operations may be changed (i.e. depending on the embodiment).

FIG. 3 shows a process for scaling objects by scaling properties of the objects.

After a start operation, the process 300 flows to operation 310, where the objects and content to scale within the document are determined. All/portion of the document may be scaled that may be determined by one or more selected ranges of the document (See FIG. 4 and related discussion). For example, all/portion of the content (text, objects, images) within the document may be scaled.

Moving to operation 320, a scaling factor is determined. The scaling factor may be determined manually/automatically. For example, a user may select a readability mode that automatically determines a scaling factor to apply to the document. The scaling factor may also be set by a user (e.g. a user uses a slider element or some other user interface element to select a scaling factor). The scaling factor may be smaller/larger than a current scaling factor for the document.

Flowing to operation 330, the properties to scale for each object are determined. According to an embodiment, the properties that affect a physical layout of the object/content are selected for scaling. Generally, any property of the object that specifies a physical size of the object is scaled. According to an embodiment, each parameter that is identified as a physical parameter that affects layout of the object/content is selected for scaling. According to another embodiment, at least a majority of the parameters that affect the physical layout are selected for scaling.

Transitioning to operation 340, the determined parameters of the object/content are scaled to the scaling factor. According to an embodiment, when scaling a parameter would result in an unreadable object (e.g. a line is too thin to be seen), the parameter may be set to a default minimum value and/or a default maximum value.

Moving to operation 350, the content of the objects is scaled. The content may include textual content, images, as well as other objects. For example, a table object may include one or more other objects (e.g. spreadsheet object, table object . . . ). For each object that is contained within the object, the scaling process determines the properties of the object to scale and scales the determined properties.

The process then moves to an end operation and returns to processing other actions.

FIG. 4 illustrates a process for accessing a document and selecting a range within the document for scaling.

After a start operation, process 400 flows to operation 410, where a document is accessed. The document may be a word-processing document, a spreadsheet document, a presentation document (e.g. a slide), a drawing, and the like.

Moving to operation 420, a range and/or type of object(s) of the document to be scaled is determined. One or more ranges of the document and one or more types of objects to scale may be selected. According to an embodiment, a user may select different ranges of the document to scale. The ranges may also be automatically selected. For example, the application may determine that any section that includes an object is to be scaled.

Flowing to operation 430, the objects within the selected range(s) and/or the type of objects selected within the document are determined.

Transitioning to operation 440, the determined objects/content within the selected range and/or are of the type of object selected for scaling are scaled based on the chosen scaling factor.

The process then moves to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for scaling objects while maintaining object structure, comprising:
determining a scaling factor;
determining an object that comprises content to scale;
determining properties of the object to scale that affect a layout of the object;
scaling each of the determined properties based on the scaling factor; and
scaling the content of the object based on the scaling factor.

2. The method of claim 1, further comprising determining at least one of: a range within a document to apply the scaling factor and a type of object to apply the scaling factor.

3. The method of claim 1, wherein determining the object that comprises content to scale comprises determining each object that is contained within the object.

4. The method of claim 3, wherein scaling each of the determined properties based on the scaling factor comprises scaling each object within the object based on the determined properties for each of the objects.

5. The method of claim 1, wherein determining the properties of the object to scale that affect the layout of the object comprises determining each property of the object that has a physical size.

6. The method of claim 1, wherein scaling each of the determined properties based on the scaling factor comprises determining when the scaling results in a scaled property falling below a minimum size and setting the property to the minimum size.

7. The method of claim 1, wherein determining properties of the object to scale that affect a layout of the object comprises determining at least a majority of the properties that affect the layout of the object.

8. The method of claim 1, wherein determining properties of the object to scale that affect the layout of the object comprises determining: a width, a height, a border width, and a padding to scale based on the scaling factor.

9. A computer-readable medium having computer-executable instructions for scaling objects while maintaining object structure, comprising:
accessing a document comprising an object and text;
determining a scaling factor;
determining properties of the object to scale that affect a layout of the object;
scaling each of the determined properties of the object based on the scaling factor; and
scaling text of the document based on the scaling factor.

10. The computer-readable medium of claim 9, wherein determining the scaling factor comprises determining a different scaling factor for at least one of: each range determined for scaling and each type of object determined for scaling.

11. The computer-readable medium of claim 9, wherein determining the object that comprises content to scale comprises determining each object that is contained within the object.

12. The computer-readable medium of claim 11, wherein scaling each of the determined properties comprises scaling each object within the object based on the determined properties for each of the objects.

13. The computer-readable medium of claim 9, wherein determining the properties of the object to scale that affect the layout of the object comprises determining each property of the object that has a physical size.

14. The computer-readable medium of claim 9, wherein scaling each of the determined properties comprises determining when the scaling results in a scaled property falling below a minimum size.

15. The computer-readable medium of claim 9, wherein determining properties of the object to scale that affect a layout of the object comprises determining at least a majority of the properties that specify a physical size.

16. The computer-readable medium of claim 9, wherein determining properties of the object to scale that affect the layout of the object comprises determining: a width, a height, a border width, and a padding to scale based on the scaling factor.

17. A system for scaling objects while maintaining object structure, comprising:
a processor and a computer-readable medium;
an operating environment stored on the computer-readable medium and executing on the processor; and
an scaling manager operating under the control of the operating environment and operative to:
accessing a document comprising an object and text;
determining a scaling factor;
determining a majority of properties of the object to scale that specify a physical size relating to the object;
scaling each of the determined properties of the object based on the scaling factor; and
scaling text of the document based on the scaling factor.

18. The system of claim 17, wherein determining the object that comprises content to scale comprises determining each object that is contained within the object.

19. The system of claim 18, wherein scaling each of the determined properties comprises scaling each object within the object based on the determined properties for each of the objects.

20. The system of claim 17, wherein determining properties of the object to scale that affect the layout of the object comprises determining: a width, a height, a border width, and a padding to scale based on the scaling factor.
